(19) United States
(12) Patent Application Publication
(10) Pub. No.: US 2024/0128611 A1
(43) Pub. Date: Apr. 18, 2024

(54) POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventor: Hiroaki KAWASE, Kakogawa-shi (JP)

(21) Appl. No.: 18/461,509

(22) Filed: Sep. 6, 2023

(30) Foreign Application Priority Data
Oct. 13, 2022 (JP) 2022-164714

(51) Int. Cl. H01M 50/566; H01M 10/04

(52) U.S. Cl. CPC H01M 50/566; H01M 10/0431; H01M 50/103

(57) ABSTRACT

A power storage device includes a flat wound electrode body, a case, and a positive terminal ultrasonically welded to a positive current collecting part of the electrode body. A surface-welded portion of a welded portion formed on a laminated current collecting part of the positive current collecting part has an outer periphery of a rectangular shape and corresponds to a virtual surface-welded portion configured such that the virtual surface-welded portion is rotated by 45 degrees or less in a rotation direction in which a closest virtual corner is moved away from an electrode body main part. A distance from a reference position to a closest corner is longer than a virtual distance from the reference position to the closest virtual corner.

### CROSS-REFERENCE TO RELATED APPLICATIONS

This application is based upon and claims the benefit of priority from the prior Japanese Patent Application No. 2022-164714 filed on Oct. 13, 2022, the entire contents of which are incorporated herein by reference.

### BACKGROUND

### Technical Field

The present disclosure relates to a power storage device including a flat wound electrode body, a case housing the electrode body therein, and a positive terminal fixed to the case and joined to a positive current collecting part of the electrode body by ultrasonic welding.

### Related Art

In a battery including a flat wound electrode body, it has been found that a minute short circuit is likely to occur in a specific part of the electrode body. An outer surface of the electrode body, a first virtual boundary surface that is provided virtually at a boundary between an electrode body main part and a positive current collecting part of the electrode body, and a pair of second virtual boundary surfaces, which are respectively provided virtually at boundaries between an electrode flat portion and a pair of electrode R portions of the electrode body, mutually intersect at four virtual intersections, and the above-described specific part is a portion around a closest virtual intersection (hereinafter, also referred to as “reference position”) which is the closest position out of the four virtual intersections closest to a surface-welded portion of a welded portion formed by welding to a positive terminal. Examples of a conventional art disclosing a battery including a flat wound electrode body include Japanese Unexamined Patent Application Publication No. 2021-089856 (see FIG. 1 to FIG. 3, etc. in Japanese Unexamined Patent Application Publication No. 2021-089856).

### SUMMARY

### Technical Problems

In the battery, portions of a positive electrode foil exposed portion constituting a positive current collecting part of an electrode body are laminated in an electrode body thickwise direction to form a laminated current collecting part, and a positive terminal is ultrasonically welded to the laminated current collecting part. Specifically, an anvil of an ultrasonic welder is placed on one side in the electrode body thickwise direction of the positive current collecting part via the positive terminal, and a horn of the ultrasonic welder is placed on the other side in the electrode body thickwise direction of the positive current collecting part. Ultrasonic vibration is applied while the horn is being pressed on the positive current collecting part from the other side in the electrode body thickwise direction toward the one side (the anvil side, the positive terminal side). Accordingly, the laminated current collecting part is formed in the positive current collecting part, and the positive terminal is ultrasonically welded to the laminated current collecting part. A weld mark remains on a portion where the horn is pressed in the laminated current collecting part.

In the ultrasonic welding, a positive current collecting foil in the positive electrode foil exposed portion spirally wound such that portions thereof are spaced from one another is largely moved and deformed when the horn is pressed on the positive current collecting part. Specifically, in the positive current collecting part, a V-shaped groove-like recess, which extends in a tapering V shape from the periphery of the welded portion with the positive terminal toward the above-mentioned reference position and is recessed on the inner side in the electrode body thickwise direction, is formed. In the V-shaped groove-like recess, a portion around a tip end close to the reference position has a shape having a narrow groove width and a steeply increased depth. Accordingly, in the portion around the tip end of the V-shaped groove-like recess, the positive current collecting foil positioned on the outermost periphery sharply bends on the inner side in the electrode body thickwise direction, and large stress is applied to a separator between the positive current collecting foil and a corner of an outside end portion in an axial direction of a negative electrode plate positioned just on the inner side of the positive current collecting foil.

When vibration in ultrasonic welding is applied in this state, a hole may be made in a portion where the large stress is applied in the separator, and thus a minute short circuit may occur between the positive current collecting foil on the outermost periphery and the corner of the outside end portion of the negative electrode plate just on the inner side of the positive current collecting foil on the outermost periphery. In addition, burr is formed on the outside end portion of the negative electrode plate in some cases, and, in the vicinity of the reference position (the portion around the tip end of the V-shaped groove-like recess), the burr may penetrate through the separator due to the above-described stress, which could cause the above-described minute short circuit. For these reasons, a minute short circuit is likely to occur in the vicinity of the reference position of the electrode body (the portion around the tip end of the V-shaped groove-like recess).

As a method for preventing occurrence of such a minute short circuit, it is conceivable that an area of the surface-welded portion is reduced, whereby the depth of the recess is allowed to gently change and the positive current collecting foil positioned on the outermost periphery is allowed to gently bend on the inner side in the vicinity of the reference position (the portion around the tip end of the V-shaped groove-like recess). However, such reduction in the area of the surface-welded portion is not preferable when weld strength between the positive terminal and the positive current collecting part (laminated current collecting part) of the electrode body needs to be sufficiently ensured.

Alternatively, as another method for preventing occurrence of a minute short circuit, it is also conceivable that the entire surface-welded portion is placed away from the reference position, whereby the depth of the recess is allowed to gently change and the positive current collecting foil positioned on the outermost periphery is allowed to gently bend on the inner side in the vicinity of the reference position (the portion around the tip end of the V-shaped groove-like recess). However, the positive terminal needs to be elongated in this case, and thus such a method is not preferable.

The present disclosure has been made in view of such circumstances, and provides a power storage device including a flat wound electrode body and capable of inhibiting occurrence of a minute short circuit in the vicinity of the reference position as described above in the electrode body.

### Means of Solving the Problems

(1) One aspect of the present disclosure for solving the above problem is to provide a power storage device comprising an electrode body of a flat wound type, a case housing the electrode body therein, and a positive terminal, wherein the electrode body of the flat wound type is formed by winding a strip-shaped positive electrode plate and a strip-shaped negative electrode plate with a pair of strip-shaped separators thereon in a flat shape around a winding axis, the positive electrode plate has a positive electrode body part in which a positive active material layer of strip shape extending in a longitudinal direction is formed on a positive current collecting foil of a strip shape extending in the longitudinal direction, and a positive electrode foil exposed portion that has a strip shape extending in the longitudinal direction along a peripheral edge on one side in a widthwise direction of the positive current collecting foil and that has no positive active material layer such that the positive current collecting foil is exposed, the electrode body of the flat wound type includes: an electrode body main part in which the positive electrode body part of the positive electrode plate and the negative electrode plate oppose each other interposed with the separator therebetween; and a positive current collecting part in which the positive electrode foil exposed portion protrudes spirally from the electrode body main part to one side in an axial direction along the winding axis, the positive terminal is fixed to the case and joined by ultrasonic welding to a laminated current collecting part in which portions of the positive electrode foil exposed portion are overlapped in an electrode body thickwise direction of the electrode body of a flat shape in the positive current collecting part of the electrode body, in a welded portion formed in the laminated current collecting part by the ultrasonic welding, a surface-welded portion that appears on an outer surface of the laminated current collecting part has a rectangular outer periphery, and when an outer surface of the electrode body, a first virtual boundary surface that is orthogonal to the axial direction and that is provided virtually at a boundary between the electrode body main part and the positive current collecting part of the electrode body, and a pair of second virtual boundary surfaces that are parallel to the axial direction and the electrode body thickwise direction and that are respectively provided virtually at boundaries between an electrode flat portion, in which the positive electrode plate, the negative electrode plate, and the separators are overlapped so as to form a plate-like shape, and a pair of electrode R portions, in each of which the positive electrode plate, the negative electrode plate, and the separators are overlapped so as to be curved in a semi-cylindrical shape, of the electrode body, intersect one another at four virtual intersections, out of the four virtual intersections, a position of a closest virtual intersection closest to the surface-welded portion is defined as a reference position, out of four corners of the surface-welded portion, a corner closest to the reference position is defined as a closest corner, a linear distance from the reference position to the closest corner on the outer surface of the electrode body is defined as a distance A, a virtual surface-welded portion having the same rectangular shape as the surface-welded portion and having the same rectangle center of the rectangular shape as the surface-welded portion is assumed to be virtually arranged on the outer surface of the laminated current collecting part such that two parallel sides forming the rectangular shape are each parallel to the axial direction, out of four virtual corners of the virtual surface-welded portion, a virtual corner closest to the reference position is defined as a closest virtual corner, and a linear distance from the reference position to the closest virtual corner on the outer surface of the electrode body is defined as a virtual distance B, the surface-welded portion corresponds to the virtual surface-welded portion that is rotated about the rectangle center as a rotation center at 45 degrees or less in such a rotation direction that the closest virtual corner is moved away from the electrode body main part, and the distance A is longer than the virtual distance B (A>B).

In the above-described power storage device, in the welded portion formed in the laminated current collecting part of the positive current collecting part of the electrode body, the surface-welded portion that appears on the outer surface of the laminated current collecting part has a rectangular outer periphery. The welded portion having such a rectangular surface-welded portion is easily formed.

Furthermore, as described above, the surface-welded portion is configured by rotating the virtual surface-welded portion such that the distance A from the reference position of the electrode body to the closest corner of the surface-welded portion is longer than the virtual distance B from the reference position to the closest virtual corner of the virtual surface-welded portion. As compared to a case (described below as a comparative embodiment) in which the virtual surface-welded portion is formed in the electrode body, in the electrode body in which the welded portion having such a surface-welded portion is formed, the depth of the recess gently changes and the positive current collecting foil positioned on the outermost periphery gently bends on the inner side in the electrode body thickwise direction in the vicinity of the reference position (a portion around the tip end of a V-shaped groove-like recess). Accordingly, damage as described above is less likely to occur in the separator in the vicinity of the reference position, and occurrence of a minute short circuit can be inhibited in the vicinity of the reference position.

The above-mentioned surface-welded portion has the same size as the virtual surface-welded portion, and thus weld strength between the positive terminal and the laminated current collecting part of the positive current collecting part of the electrode body may be same as the weld strength obtained when the virtual surface-welded portion is provided.

In addition, the above-mentioned surface-welded portion has the same rectangle center as the virtual surface-welded portion, and the entire surface-welded portion is provided without being positioned away from the reference position, and thus the positive terminal needs not to be elongated.

Examples of the “power storage device” include secondary batteries such as a lithium-ion secondary battery, capacitors such as a lithium ion capacitor, and an all-solid-state battery.

(2) Further, the power storage device according to the above (1) is, preferably a dimension of the electrode body in the electrode body thickwise direction is 10 mm or more.

Advantageously, the larger the dimension of the electrode body in the electrode body thickwise direction is formed, the more the device capacity of the power storage device can be increased. However, in the case where the dimension of the electrode body in the electrode body thickwise direction is 10 mm or more, when the positive terminal is ultrasonically welded to a part of the positive current collecting part of the electrode body as the laminated current collecting part, the positive current collecting part (the positive current collecting foil in the positive electrode foil exposed portion) is largely deformed, so that the depth of the recess is steeply increased and the positive current collecting foil on the outermost periphery sharply bends on the inner side in the vicinity of the reference position of the electrode body (the portion around the tip end of the V-shaped groove-like recess). Accordingly, the minute short circuit as described above is likely to occur. Therefore, the present disclosure is particularly preferably applied to a power storage device in which such a minute short circuit is likely to occur and the dimension in the electrode body thickwise direction is 10 mm or more.

### BRIEF DESCRIPTION OF THE DRAWINGS

FIG. 1 is a perspective view of a battery according to an embodiment;

FIG. 2 is a sectional view of the battery according to the embodiment along a battery height direction and a battery thickwise direction;

FIG. 3 is a sectional view taken along a line A-A in FIG. 2 of the battery according to the embodiment along the battery height direction and a battery lateral direction;

FIG. 4 is a sectional view taken along a line B-B in FIG. 2 of the battery according to the embodiment along the battery height direction and the battery lateral direction;

FIG. 5 is a partial enlarged plan view of a portion including a reference position and a surface-welded portion in an electrode body of the battery according to the embodiment when seen in an electrode body thickwise direction;

FIG. 6 is a partial enlarged sectional view of a portion including the reference position in the electrode body of the battery according to the embodiment along an axial direction and the electrode body thickwise direction; and

FIG. 7 is a partial enlarged sectional view of a portion including a reference position, which corresponds to that in FIG. 6, in an electrode body of a battery according to a comparative embodiment along an axial direction and an electrode body thickwise direction.

### DETAILED DESCRIPTION OF THE EXEMPLARY EMBODIMENTS

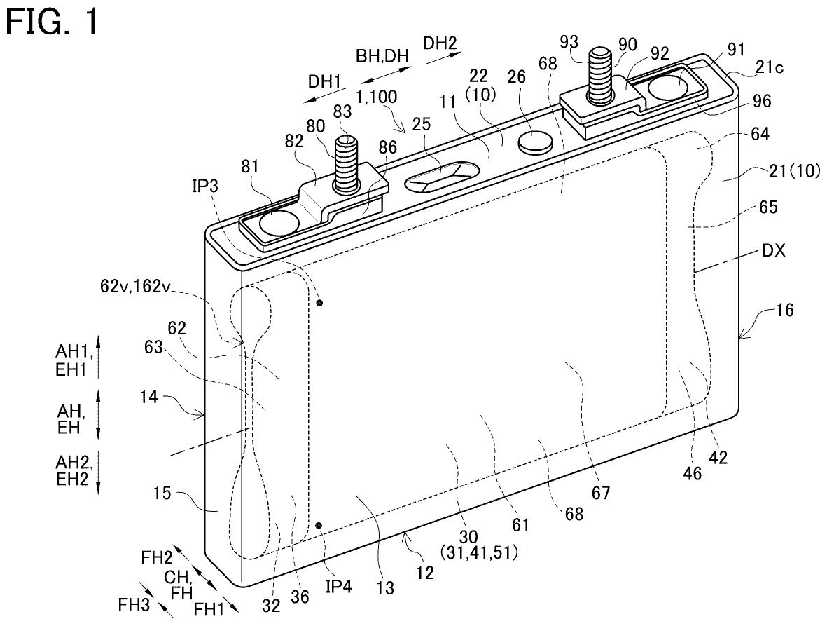

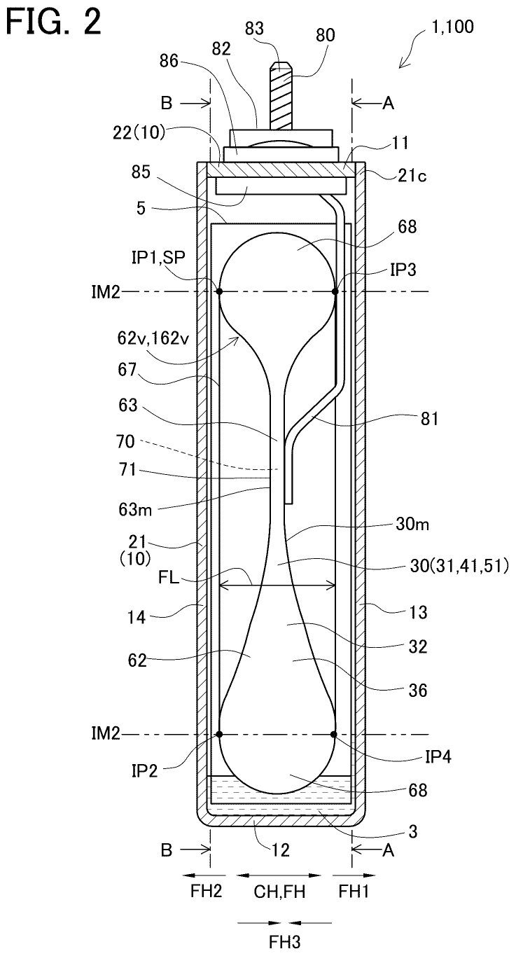

Hereinafter, an embodiment of the present disclosure will be described with reference to the drawings. FIG. 1 is a perspective view of a battery (power storage device) 1 according to the present embodiment, and FIG. 2 to FIG. 4 each show a sectional view of the battery 1. Hereinafter, for the following description, a battery height direction AH, a battery lateral direction BH, and a battery thickwise direction CH of the battery 1, and an axial direction DH, an electrode body widthwise direction EH, and an electrode body thickwise direction FH of an electrode body 30 are defined as directions indicated in FIG. 1 to FIG. 4. The battery 1 is a rectangular (rectangular parallelepiped box-like shaped) sealed lithium-ion secondary battery that is installed in vehicles such as a hybrid car, a plug-in hybrid car, and an electric automobile.

The battery 1 includes a case 10, the flat wound electrode body 30 housed in the case 10, a positive terminal 80 and a negative terminal 90 supported on a case upper part 11 of the case 10, etc. In the case 10, the electrode body is covered with a bag-shaped insulating holder 5 that is formed of an insulation film and that is open on an upper side AH1 in the battery height direction AH. An electrolyte 3 is stored in the case 10, the electrode body 30 is impregnated with a part of the electrolyte 3, and the remainder is accumulated on a case bottom part 12 of the case 10.

The case 10 has a rectangular parallelepiped box-like shape made of metal (aluminum in the present embodiment) and includes the rectangular case upper part 11 located on the upper side AH1 in the battery height direction AH, the rectangular case bottom part 12 opposed to the case upper part 11 and located on a lower side AH2 in the battery height direction AH, and four rectangular case side portions (a pair of case long-side portions 13, 14 and a pair of case short-side portions 15, 16) connecting the case upper part 11 and the case bottom part 12. The case 10 includes a bottomed rectangular tubular body 21 having a rectangular annular opening portion 21c on the upper side AH1, and a lid 22 laser-welded to the body 21 over the entire periphery of the body 21 so as to close the opening portion 21c. A safety valve 25, which is broken and opened when the internal pressure of the case 10 exceeds a valve opening pressure, is provided in the lid 22. A liquid inlet 22k for communication between the inside and the outside of the case 10 is provided in the lid 22 and is hermetically sealed by a disc-shaped sealing member 26 made of aluminum.

The positive terminal 80 including an inner terminal member 81, an outer terminal member 82, and a terminal bolt 83 that are made of aluminum is fixed to the case upper part 11 (lid 22) of the case 10 via an inner insulating member 85 and an outer insulating member 86 that are made of resin so as to be insulated from the case 10. The positive terminal 80 is joined and conducted to a positive current collecting part 62 of the electrode body 30 in the case 10 and extends through the case upper part 11 to the outside of the case 10. The negative terminal 90 including an inner terminal member 91, an outer terminal member 92, and a terminal bolt 93 that are made of copper is fixed to the case upper part 11 via an inner insulating member 95 and an outer insulating member 96 that are made of resin so as to be insulated from the case 10. The negative terminal 90 is joined and conducted to a negative current collecting part 64 of the electrode body 30 in the case 10 and extends through the case upper part 11 to the outside of the case 10.

The positive terminal 80 and the negative terminal 90 have a similar configuration, and thus will be collectively described below. The inner terminal member 81 of the positive terminal 80 and the inner terminal member 91 of the negative terminal 90 are mainly disposed inside the case 10 and are each joined to the positive current collecting part 62 or the negative current collecting part 64 of the electrode body 30 while extending through the case upper part 11 to the outside of the case 10 and being respectively swaged and connected to the outer terminal members 82, 92. On the other hand, the outer terminal members 82, 92 are disposed outside the case 10, and each has a crank shape (Z shape). The terminal bolts 83, 93 are also disposed outside the case 10. The terminal bolts 83, 93 protrude from the lower side AH2 of the outer terminal members 82, 92 through the outer terminal members 82, 92 to the upper side AH1 with respect to the outer terminal members 82, 92, respectively.

The inner insulating members 85, 95 are mainly disposed inside the case to insulate the inner terminal members 81, 91 of the positive terminal 80 or the negative terminal 90 from the case upper part 11. On the other hand, the outer insulating members 86, 96 are disposed outside the case 10 to insulate the outer terminal members 82, 92 and the terminal bolts 83, 93 of the positive terminal 80 or the negative terminal 90 from the case upper part 11.

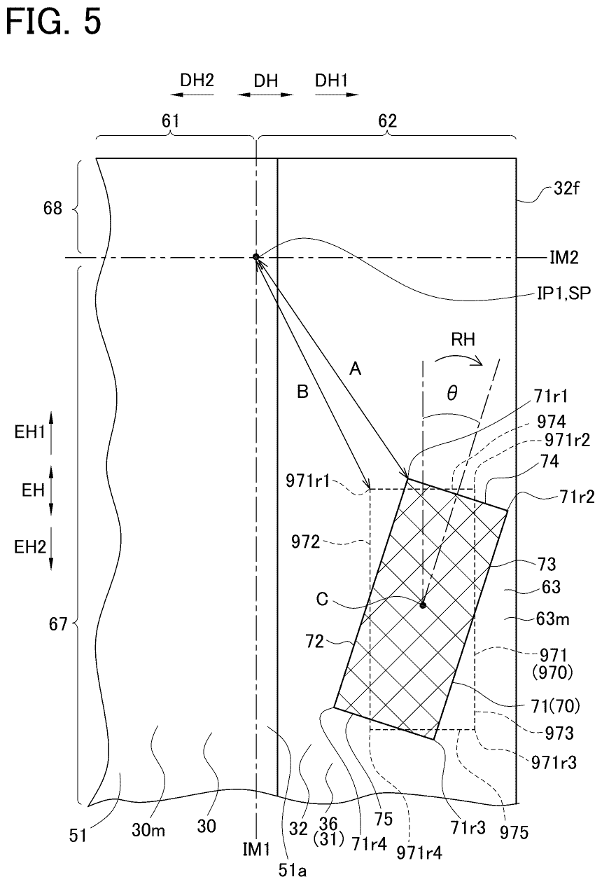

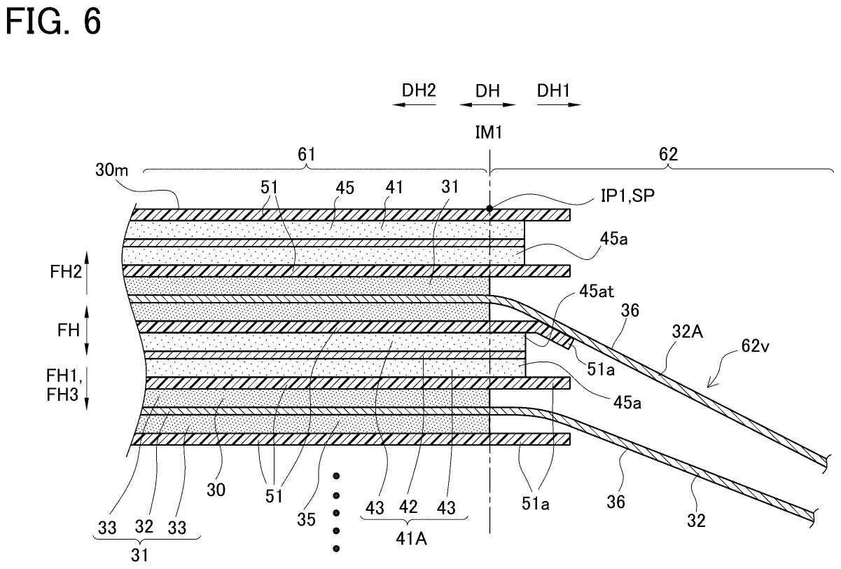

Next, the electrode body 30 will be described (see not only FIG. 1 to FIG. 4 but also FIG. 5 and FIG. 6). A strip-shaped positive electrode plate 31 and a strip-shaped negative electrode plate 41 are overlapped with a pair of separators 51 formed of strip-shaped porous films made of resin such that the separators are interposed alternately with the electrode plates, and the electrode plates and the separators are wound around a winding axis DX in a cylindrical shape, and then are compressed in a flat shape, whereby the electrode body 30 is obtained. The flat-shaped electrode body 30 has a dimension in the axial direction DH along the winding axis DX of 117 mm, a dimension in the electrode body widthwise direction EH of 58 mm, and a dimension FL (see FIG. 2) in the electrode body thickwise direction FH of 20 mm. The electrode body 30 is housed in the case 10 such that the axial direction DH corresponds to the battery lateral direction BH, the electrode body widthwise direction EH corresponds to the battery height direction AH, and the electrode body thickwise direction FH corresponds to the battery thickwise direction CH.

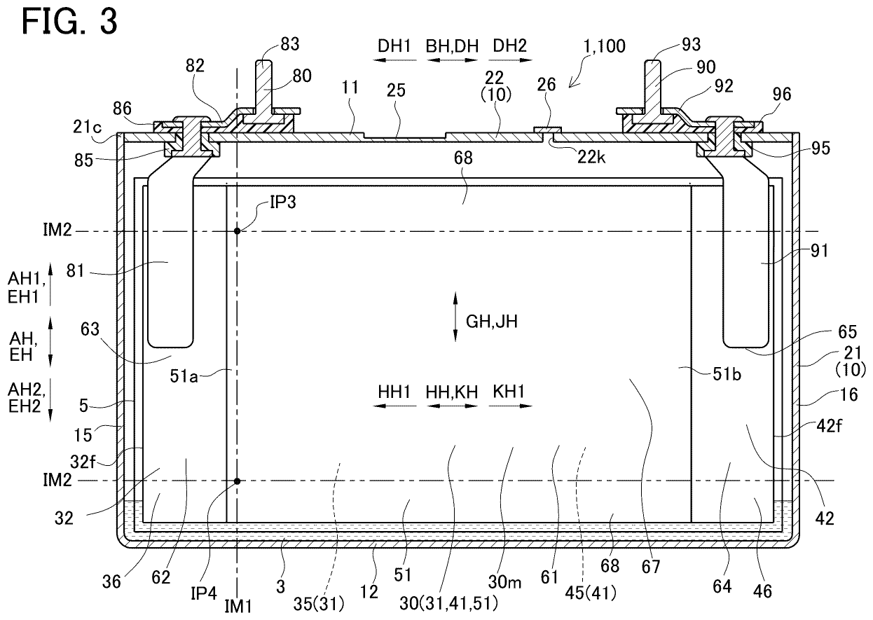

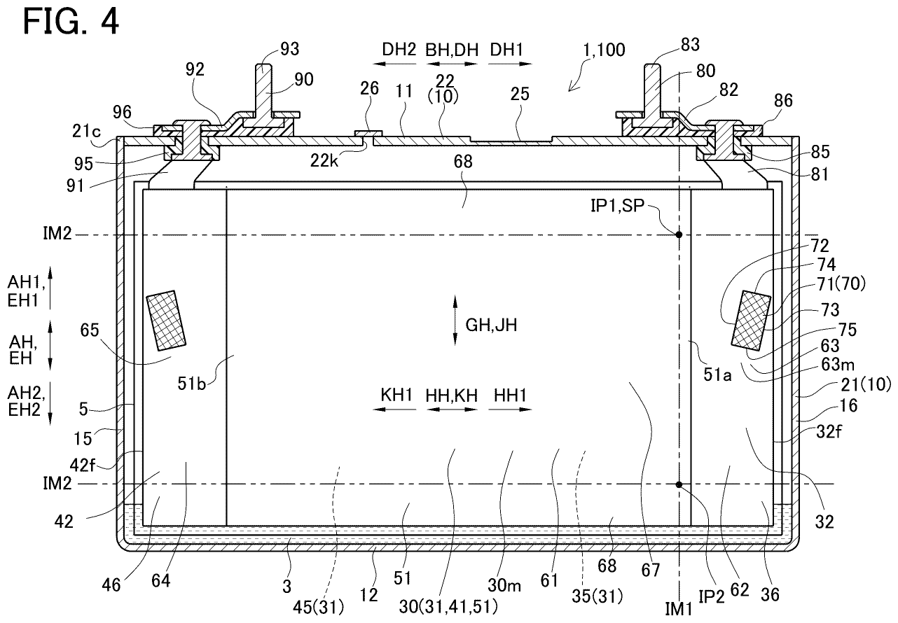

The positive electrode plate 31 has a positive current collecting foil 32 formed of a strip-shaped aluminum foil that extends in a longitudinal direction GH (see FIG. 3 and FIG. 4). In a region extending over a part of the positive current collecting foil 32 in a widthwise direction HH and in the longitudinal direction GH, strip-shaped positive active material layers 33 (see FIG. 6) extending in the longitudinal direction GH are respectively formed on both principal surfaces of the positive current collecting foil 32. Each positive active material layer 33 includes positive active material particles capable of occluding and releasing lithium ions, conductive particles, and a binding agent. In the positive electrode plate 31, a strip-shaped portion having the positive active material layers 33 on the positive current collecting foil 32 constitutes a positive electrode body part 35 as described above. On the other hand, a strip-shaped portion extending in the longitudinal direction GH along a peripheral edge 32f on one side HH1 in the widthwise direction HH of the positive current collecting foil 32 constitutes a positive electrode foil exposed portion 36 that has no positive active material layer 33 such that the positive current collecting foil 32 is exposed.

The negative electrode plate 41 has a negative current collecting foil 42 formed of a strip-shaped copper foil that extends in a longitudinal direction JH (see FIG. 3 and FIG. 4). In a region extending over a part of the negative current collecting foil 42 in a widthwise direction KH and in the longitudinal direction JH, strip-shaped negative active material layers 43 (see FIG. 6) extending in the longitudinal direction JH are respectively formed on both principal surfaces of the negative current collecting foil 42. Each negative active material layer 43 includes negative active material particles capable of occluding and releasing lithium ions, a binding agent, and a thickener. In the negative electrode plate 41, a strip-shaped portion having the negative active material layers 43 on the negative current collecting foil 42 constitutes a negative electrode body part 45. On the other hand, a strip-shaped portion extending in the longitudinal direction JH along a peripheral edge 42f on one side KH1 in the widthwise direction KH of the negative current collecting foil 42 constitutes a negative electrode foil exposed portion 46 that has no negative active material layer 43 such that the negative current collecting foil 42 is exposed.

A central portion in the axial direction DH of the electrode body 30 is an electrode body main part 61 in which the entire positive electrode body part of the positive electrode plate 31 and a part of the negative electrode body part 45 of the negative electrode plate 41 oppose each other with the separator 51 interposed therebetween. The negative electrode body part 45 is wider than the positive electrode body part 35. Thus, both outside end portions in the axial direction DH of the negative electrode body part 45 do not oppose the positive electrode body part 35, and thus the both outside end portions are not included in the electrode body main part 61.

In the electrode body 30, a portion on one side DH1 in the axial direction DH with respect to the electrode body main part 61 is the positive current collecting part 62 in which the positive electrode foil exposed portion 36 of the positive electrode plate 31 protrudes spirally from the electrode body main part 61 to the one side DH1 in the axial direction DH. The dimension in the axial direction DH of the positive current collecting part 62 is 8.5 mm. The positive current collecting part 62 is mainly formed of the positive electrode foil exposed portion 36, but the positive current collecting part 62 also includes an outside end portion 45a (see FIG. 6) not opposing the positive electrode body part 35 on one side DH1 in the axial direction DH of the negative electrode plate 41, and outside end portions 51a not opposing the positive electrode body part on the one side DH1 in the axial direction DH of the separators 51 in addition to the positive electrode foil exposed portion 36.

In a part of the positive current collecting part 62, specifically, a central portion on one side EH1 in the electrode body widthwise direction EH, the spiral positive electrode foil exposed portions 36 are overlapped in the electrode body thickwise direction FH to form a laminated current collecting part 63. The inner terminal member 81 of the positive terminal 80 is joined to the laminated current collecting part 63 by ultrasonic welding. In a welded portion 70 formed in the laminated current collecting part 63, a portion that appears on an outer surface 63m of the laminated current collecting part 63 is a surface-welded portion 71 as described above. The surface-welded portion 71 will be described below.

In the electrode body 30, a portion on the other side DH2 in the axial direction DH with respect to the electrode body main part 61 is the negative current collecting part 64 in which the outside end portion (not shown) of the negative electrode body part 45 and the negative electrode foil exposed portion 46 of the negative electrode plate 41 protrude spirally from the electrode body main part 61 to the other side DH2 in the axial direction DH. The dimension in the axial direction DH of the negative current collecting part 64 is 8.5 mm as in the positive current collecting part 62. The negative current collecting part 64 also includes outside end portions 51b, which do not oppose the positive electrode body part 35, on the other side DH2 in the axial direction DH of the separators 51.

In a part of the negative current collecting part 64, specifically, a central portion on one side EH1 in the electrode body widthwise direction EH, the spiral negative electrode foil exposed portions 46 are overlapped in the electrode body thickwise direction FH to form a laminated current collecting part 65. The inner terminal member 91 of the negative terminal 90 is joined to the laminated current collecting part 65 by ultrasonic welding.

The electrode body 30 includes an electrode flat portion 67 and a pair of electrode R portions 68. Specifically, the electrode flat portion 67 is a portion in which the positive electrode plate 31, the negative electrode plate 41, and the separators 51 are overlapped so as to form a plate-like shape. On the other hand, each electrode R portion 68 is a portion in which the positive electrode plate 31, the negative electrode plate 41, and the separators 51 are overlapped so as to be curved in a semi-cylindrical shape.

Here, “four virtual intersections”, a “closest virtual intersection”, and a “reference position” in the electrode body 30 as mentioned above will be described. First, a first virtual boundary surface IM1 (indicated by a chain-dotted line in FIG. 3 to FIG. 6) orthogonal to the axial direction DH is provided virtually at a boundary between the electrode body main part 61 and the positive current collecting part 62 of the electrode body 30, and a pair of second virtual boundary surfaces IM2 (each indicated by a chain-double-dashed line in FIG. 2 to FIG. 5) parallel to the axial direction DH and the electrode body thickwise direction FH (orthogonal to the electrode body widthwise direction EH) are respectively provided virtually at boundaries between the electrode flat portion 67 and the pair of electrode R portions 68 of the electrode body 30. Four intersections where an outer surface 30m of the electrode body 30, the first virtual boundary surface IM1, and the pair of second virtual boundary surfaces IM2 intersect one another are defined as virtual intersections IP1, IP2, IP3, and IP4. Out of these virtual intersections IP1 to IP4, the virtual intersection IP1 closest to the surface-welded portion 71 of the welded portion 70 formed in the laminated current collecting part 63 is defined as a closest virtual intersection IP1 (see FIG. 2, and FIG. 4 to FIG. 6). The position of the closest virtual intersection IP1 is defined as a reference position SP.

Next, the surface-welded portion 71 will be described (see FIG. 5 and FIG. 4). The surface-welded portion 71 has a rectangular outer periphery that has two parallel sides 72, 73 (each having a length of 10 mm in the present embodiment) and two parallel sides 74, 75 (each having a length of 4 mm in the present embodiment) orthogonal to the parallel sides 72, 73. Out of four corners 71r1, 71r2, 71r3, 71r4 of the surface-welded portion 71, the corner 71r1 closest to the reference position SP is defined as a closest corner 71r1 as described above. A linear distance from the reference position SP to the closest corner 71r1 on the outer surface 30m of the electrode body 30 is defined as a distance A.

As a comparative embodiment, a virtual surface-welded portion 971 (indicated by a broken line in FIG. 5), which has the same rectangular shape as the surface-welded portion 71 of the embodiment and has two parallel sides 972, 973, and two parallel sides 974, 975 orthogonal to the parallel sides 972, 973, and which has the rectangle center C of the rectangular shape same as the surface-welded portion 71, is assumed. The virtual surface-welded portion 971 is provided virtually on the outer surface 63m of the laminated current collecting part 63 of the electrode body 30 such that the two parallel sides 972, 973 are each parallel to the electrode body widthwise direction EH and the remaining two parallel sides 974, 975 are each parallel to the axial direction DH. Out of four virtual corners 971r1, 971r2, 971r3, 971r4 of the virtual surface-welded portion 971, the virtual corner 971r1 closest to the reference position SP is defined as a closest virtual corner 971r1 as described above. A linear distance from the reference position SP to the closest virtual corner 971r1 on the outer surface 30m of the electrode body 30 is defined as a virtual distance B.

In this case, the surface-welded portion 71 of the present embodiment corresponds to the virtual surface-welded portion 971 of the comparative embodiment, which is rotated about the rectangle center C as a rotation center at a rotation angle θ of 45 degrees or less (specifically, θ=30 degrees) in such a rotation direction RH (clockwise, in FIG. 5 and FIG. 4) that the closest virtual corner 971r1 is moved away from the electrode body main part 61, and the distance A is made longer than the virtual distance B (A>B).

Next, a method for manufacturing the battery 1 described above will be described. First, the strip-shaped positive electrode plate 31, the strip-shaped negative electrode plate 41, and the pair of strip-shaped separators 51 are prepared and overlapped in the order of the separator 51, the negative electrode plate 41, the separator 51, and the positive electrode plate 31, and wound around the winding axis DX in a cylindrical shape to form an electrode body (not shown) of a cylindrical shape. Then, the cylindrical electrode body is pressed to form the flat-shaped electrode body 30 having the electrode flat portion 67 and the pair of electrode R portions 68.

Separately, the lid 22, the inner terminal members 81, 91, the outer terminal members 82, 92, the terminal bolts 83, 93, the inner insulating members 85, 95, and the outer insulating members 86, 96 are prepared. The positive terminal 80 including the inner terminal member 81, the outer terminal member 82, and the terminal bolt 83 is fixed to the lid 22 via the inner insulating member 85 and the outer insulating member 86. Further, the negative terminal 90 including the inner terminal member 91, the outer terminal member 92, and the terminal bolt 93 is fixed to the lid 22 via the inner insulating member 95 and the outer insulating member 96.

Next, the positive terminal 80 fixed to the lid 22 and the negative terminal 90 fixed to the lid 22 are respectively joined to the positive current collecting part 62 of the electrode body 30 and to the negative current collecting part 64 of the electrode body 30 by ultrasonic welding. Specifically, portions of the positive electrode foil exposed portion 36, which are spirally wound with spaced apart from one another to constitute the positive current collecting portion 62, are overlapped in the electrode body thickwise direction FH to form the laminated current collecting part 63, and the inner terminal member 81 of the positive terminal 80 is ultrasonically welded to the laminated current collecting part 63.

Specifically, an anvil (not shown) of an ultrasonic welder is placed on one side FH1 in the electrode body thickwise direction FH of the positive current collecting part 62 via the inner terminal member 81 of the positive terminal 80, and a horn (not shown) of the ultrasonic welder is placed on the other side FH2 in the electrode body thickwise direction FH of the positive current collecting part 62. Ultrasonic vibration is applied while the horn is being pressed on the positive current collecting part 62 from the other side FH2 toward the one side FH1 (the anvil side, the inner terminal member 81 side of the positive terminal 80) in the electrode body thickwise direction FH. Accordingly, the laminated current collecting part 63 is formed in the positive current collecting part 62, and the inner terminal member 81 of the positive terminal 80 is ultrasonically welded to the laminated current collecting part 63, whereby the welded portion 70 including the surface-welded portion 71 having an outer periphery formed of an inner side 72, an outer side 73, a closer side 74, and a far side 75 is formed in the laminated current collecting part 63. Similarly, the inner terminal member 91 of the negative terminal 90 is also ultrasonically welded to the negative current collecting part 64 of the electrode body 30.

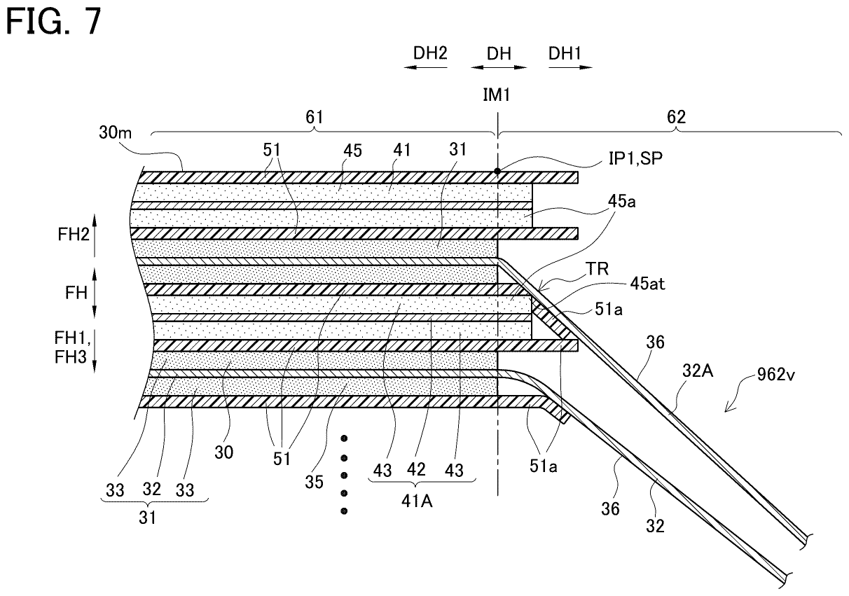

Here, in the above-described comparative embodiment (also see FIG. 7), the positive current collecting foil 32 in the positive electrode foil exposed portion 36 is largely moved and deformed when the horn for ultrasonic welding is pressed on the positive current collecting part 62. Then, in the positive current collecting part 62, there is formed a V-shaped groove-like recess 962v that extends in a tapering V shape from the periphery of a welded portion 970 welded with the inner terminal member 81 of the positive terminal 80 toward the reference position SP and that is recessed on an inner side FH3 in the electrode body thickwise direction FH. In the V-shaped groove-like recess 962v, a portion around the tip end thereof close to the reference position SP has a shape having a narrow groove width and a steeply increased depth.

Accordingly, in the portion around the tip end of the V-shaped groove-like recess 962v, a positive current collecting foil 32A (see FIG. 7) positioned on the outermost periphery sharply bends on the inner side FH3 (downward, in FIG. 7) in the electrode body thickwise direction FH. In particular, a dimension FL in the electrode body thickwise direction FH of the electrode body 30 is 10 mm or more, and thus the positive current collecting part 62 is largely deformed, so that in the portion around the tip end of the V-shaped groove-like recess 962v, the depth of the recess thereof is steeply increased and the positive current collecting foil 32A on the outermost periphery sharply bends on the inner side FH3. Then, large stress is applied to an outside end portion 51a of the separator 51 between the positive current collecting foil 32A and a corner 45at of an outside end portion 45a of the negative electrode plate 41A positioned just on the inner side of the positive current collecting foil 32A.

When vibration in ultrasonic welding is applied in this state, a hole could be made in a portion where the large stress is applied in the outside end portion 51a of the separator 51, and the positive current collecting foil 32A on the outermost periphery and the corner 45at of the outside end portion 45a of the negative electrode plate 41A positioned just on the inner side of the positive current collecting foil 32A on the outermost periphery may come into contact with each other (at a position indicated by an arrow TR in FIG. 7), which could cause a minute short circuit therebetween. In addition, burr is formed on the outside end portion 45a of the negative electrode plate 41 in some cases, and in the vicinity of the reference position SP (the portion around the tip end of the V-shaped groove-like recess 962v), the burr may penetrate through the outside end portion 51a of the separator 51 due to the above-described stress, which could cause the above-described minute short circuit.

In contrast, in the present embodiment (see FIG. 6), when the horn for ultrasonic welding is pressed on the positive current collecting part 62, a V-shaped groove-like recess 62v having substantially the same configuration as the V-shaped groove-like recess 962v of the comparative embodiment is formed in the positive current collecting part 62. However, as compared to the V-shaped groove-like recess 962v of the comparative embodiment, in the V-shaped groove-like recess 62v formed in the present embodiment, the depth of the recess gently changes and the positive current collecting foil 32A positioned on the outermost periphery gently bends on the inner side FH3 (downward in FIG. 6) in the vicinity of the reference position SP (a portion around the tip end of the V-shaped groove-like recess 62v). Accordingly, damage as described above is less likely to occur in the outside end portion 51a of the separator 51 in the vicinity of the reference position SP, and it is possible to inhibit occurrence of a minute short circuit caused when the positive current collecting foil 32A on the outermost periphery and the corner 45at of the outside end portion 45a of the negative electrode plate 41A positioned just inside the positive current collecting foil 32A on the outermost periphery come into contact with each other in the vicinity of the reference position SP.

The surface-welded portion 71 (see FIG. 5) of the present embodiment has the same size as the virtual surface-welded portion 971 of the comparative embodiment, and thus weld strength between the inner terminal member 81 of the positive terminal 80 and the laminated current collecting part 63 of the positive current collecting part 62 of the electrode body 30 may be the same as weld strength obtained when the virtual surface-welded portion 971 of the comparative embodiment is provided.

In addition, since the surface-welded portion 71 of the present embodiment has the same rectangle center C with the virtual surface-welded portion 971 of the comparative embodiment, and the entire surface-welded portion 71 is provided without being positioned away from the reference position SP, so that the inner terminal member 81 of the positive terminal 80 needs not to be elongated.

Next, the electrode body 30 is wrapped with the bag-shaped insulating holder 5. The body 21 is then prepared, the electrode body 30 covered with the insulating holder 5 is inserted in the body 21, and the opening portion 21c of the body 21 is closed with the lid 22. The peripheries of the opening portion 21c of the body 21 and the lid 22 are laser-welded with each other over the entire periphery to form the case 10. Next, the electrolyte 3 is injected in the case 10 via the liquid inlet 22k, and the electrode body 30 is impregnated with the electrolyte 3. The liquid inlet 22k is externally covered with a sealing member 26, and the sealing member 26 is welded to the lid 22 over the entire periphery thereof to hermetically seal a portion between the sealing member 26 and the lid 22. Next, charging equipment (not shown) is connected to the battery 1, and initial charging is performed on the battery 1. The battery 1 on which the initial charging has been performed is allowed to stand still for a predetermined time to age the battery 1. In this manner, the battery 1 is completed.

While the present disclosure has been described above based on the embodiment, it should be understood that the present disclosure is not limited to the embodiment but can be applied with modifications appropriately made thereto without departing from the scope of the gist of the present disclosure.

### REFERENCE SIGNS LIST

1 Battery (power storage device)
10 Case
30 Electrode body
30m Outer surface (of the electrode body)
31 Positive electrode plate
32, 32A Positive current collecting foil
32f Peripheral edge
33 Positive active material layer
33 Positive electrode body part
36 Positive electrode foil exposed portion
41, 41A Negative electrode plate
51 Separator
61 Electrode body main part
62 Positive current collecting part
63 Laminated current collecting part (of the positive current collecting part)
63m Outer surface (of the laminated current collecting part)
67 Electrode flat portion
68 Electrode R portion
70 Welded portion
71 Surface-welded portion
72, 73, 74, 75 Side (of the surface-welded portion)
71r1 Closest corner (corner of the surface-welded portion)
71r2, 71r3, 71r4 Corner (of the surface-welded portion)
80 Positive terminal
90 Negative terminal
970 Welded portion
971 Virtual surface-welded portion
972, 973, 974, 975 Side (of the virtual surface-welded portion)
971r1 Closest virtual corner (virtual corner of the virtual surface-welded portion)
971r2, 971r3, 971r4 Virtual corner (of the virtual surface welded portion)
DX Winding axis
DH Axial direction
DH1 One side (in the axial direction)
EH Electrode body widthwise direction
EH1 One side (in the electrode body widthwise direction)
FH Electrode body thickwise direction
GH Longitudinal direction (of the positive current collecting foil)
HH Widthwise direction (of the positive current collecting foil)
HH1 One side (in the widthwise direction)
RH Rotation direction
Θ Rotation angle
IM1 First virtual boundary surface
IM2 Second virtual boundary surface
IP1 Closest virtual intersection (virtual intersection)
IP2, IP3, IP4 Virtual intersection
SP Reference position
FL Dimension (of the electrode body in the electrode body thickwise direction)
A Distance (from the reference position to the closest corner)
B Virtual distance (from the reference position to the closest virtual corner)
C Rectangle center

What is claimed is:

1. A power storage device comprising an electrode body of a flat wound type, a case housing the electrode body therein, and a positive terminal, wherein
the electrode body of the flat wound type is formed by winding a strip-shaped positive electrode plate and a strip-shaped negative electrode plate with a pair of strip-shaped separators thereon in a flat shape around a winding axis,
the positive electrode plate has a positive electrode body part in which a positive active material layer of strip shape extending in a longitudinal direction is formed on a positive current collecting foil of a strip shape extending in the longitudinal direction, and a positive electrode foil exposed portion that has a strip shape extending in the longitudinal direction along a peripheral edge on one side in a widthwise direction of the positive current collecting foil and that has no positive active material layer such that the positive current collecting foil is exposed,
the electrode body of the flat wound type includes:
an electrode body main part in which the positive electrode body part of the positive electrode plate and the negative electrode plate oppose each other interposed with the separator therebetween; and
a positive current collecting part in which the positive electrode foil exposed portion protrudes spirally from the electrode body main part to one side in an axial direction along the winding axis,
the positive terminal is fixed to the case and joined by ultrasonic welding to a laminated current collecting part in which portions of the positive electrode foil exposed portion are overlapped in an electrode body thickwise direction of the electrode body of a flat shape in the positive current collecting part of the electrode body,
in a welded portion formed in the laminated current collecting part by the ultrasonic welding, a surface-welded portion that appears on an outer surface of the laminated current collecting part has a rectangular outer periphery, and
when an outer surface of the electrode body,
a first virtual boundary surface that is orthogonal to the axial direction and that is provided virtually at a boundary between the electrode body main part and the positive current collecting part of the electrode body, and
a pair of second virtual boundary surfaces that are parallel to the axial direction and the electrode body thickwise direction and that are respectively provided virtually at boundaries between an electrode flat portion, in which the positive electrode plate, the negative electrode plate, and the separators are overlapped so as to form a plate-like shape, and a pair of electrode R portions, in each of which the positive electrode plate, the negative electrode plate, and the separators are overlapped so as to be curved in a semi-cylindrical shape, of the electrode body, intersect one another at four virtual intersections,
out of the four virtual intersections, a position of a closest virtual intersection closest to the surface-welded portion is defined as a reference position,
out of four corners of the surface-welded portion, a corner closest to the reference position is defined as a closest corner,
a linear distance from the reference position to the closest corner on the outer surface of the electrode body is defined as a distance A,
a virtual surface-welded portion having the same rectangular shape as the surface-welded portion and having the same rectangle center of the rectangular shape as the surface-welded portion is assumed to be virtually arranged on the outer surface of the laminated current collecting part such that two parallel sides forming the rectangular shape are each parallel to the axial direction,
out of four virtual corners of the virtual surface-welded portion, a virtual corner closest to the reference position is defined as a closest virtual corner, and
a linear distance from the reference position to the closest virtual corner on the outer surface of the electrode body is defined as a virtual distance B,
the surface-welded portion corresponds to the virtual surface-welded portion that is rotated about the rectangle center as a rotation center at 45 degrees or less in such a rotation direction that the closest virtual corner is moved away from the electrode body main part, and the distance A is longer than the virtual distance B (A>B).

2. The power storage device according to claim 1, wherein a dimension of the electrode body in the electrode body thickwise direction is 10 mm or more.
